(19) United States
(12) Patent Application Publication
(10) Pub. No.: US 2017/0136635 A1
(43) Pub. Date: May 18, 2017

(54) AIRCRAFT EGRESS AND MULTIFUNCTION TOOL

(71) Applicant: Thomas R. Johnston, Mint Hill, NC (US)

(72) Inventor: Thomas R. Johnston, Mint Hill, NC (US)

(21) Appl. No.: 15/350,058

(22) Filed: Nov. 13, 2016

Related U.S. Application Data
(60) Provisional application No. 62/255,725, filed on Nov. 16, 2015.

(51) Int. Cl. B26B 11/00; B26B 5/00; B25F 1/02; B23D 51/10

(52) U.S. Cl. CPC B26B 11/00; B23D 51/10; B26B 5/00; B25F 1/02

(57) ABSTRACT

A multifunction hand tool is provided for mounting thereon a one-half inch universal tang reciprocating saw blade of the type having a rectangular tang portion extending from a blade and a registration tab extending from the rectangular tang portion. The multifunction tool has a handle body that includes: a first end portion extending in a first longitudinal direction; a second end portion extending in a second longitudinal direction opposite the first longitudinal direction; and a recess formed in the second end portion and shaped to receive and engage a rectangular tang portion and a registration tab of a one-half inch universal tang reciprocating saw blade.

### CROSS-REFERENCE TO RELATED APPLICATION

This application claims the benefit of priority of U.S. provisional patent application No. 62/255,725, titled “AIRCRAFT EGRESS AND MULTIFUNCTION TOOL,” filed on Nov. 16, 2015, which is incorporated herein in its entirety by this reference.

### TECHNICAL FIELD

The present disclosure relates to hand tools. More particularly, the present disclosure relates to multifunction tools for aircraft egress, survival, and other uses.

### BACKGROUND

Aircraft pilots and other crew members may need to exit a downed, burning or otherwise failed aircraft or other vehicle. In such circumstances, any equipment needed for their escape needs to be readily available, convenient to carry and wield, and needs to be as versatile as possible so as to perform an unpredictable variety of functions. To assure its availability, any egress-essential tool may ultimately be carried at all times by savvy crew members and thus may be used for many purposes unrelated to aircraft egress. Current egress tools are typically associated with or contained in medical and other emergency equipment kits, and their functions are so limited as to fail to appeal to crew members as general-carry multifunction tools.

Once successful escape from an aircraft or other troubled vehicle is accomplished, further challenges may arise including survival in outdoor conditions at any climate and limited supplies and tools may be on hand. Thus, any aircraft or other vehicle egress tool may continue to serve to assure survival. Whether or not used for vehicle egress, outdoor oriented people such as backpackers and other adventurists are always looking for new manners in which to reduce the items needed for a given adventure. Beyond emergency and recreational use, craftsmen in a variety of trades and many others who tackle repairs and other tasks with limited tools can find uses for an improved multifunction tool 100.

Whether or not used for emergency or survival purposes, it is advantageous for a tool having any cutting or sawing edges to have replaceable bits or blades drawn from available standard configurations.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a multifunction hand tool is provided for mounting thereon a one-half inch universal tang reciprocating saw blade of the type having a rectangular tang portion extending from a blade and a registration tab extending from the rectangular tang portion. The multifunction tool has a handle body that includes: a first end portion extending in a first longitudinal direction; a second end portion extending in a second longitudinal direction opposite the first longitudinal direction; and a recess formed in the second end portion and shaped to receive and engage a rectangular tang portion and a registration tab of a one-half inch universal tang reciprocating saw blade.

In at least one example, the multifunction hand tool is non-powered.

In at least one example, the recess is defined between a longitudinally extending first bracing surface and a longitudinally extending second bracing surface.

In at least one example, the second bracing surface, for engaging a rectangular rear tang portion and a registration tab of a one-half inch universal tang reciprocating saw blade, is longer than the first bracing surface, for engaging a rectangular rear tang portion of a one-half inch universal tang reciprocating saw blade.

In at least one example, a recess for receiving a trapezoidal utility blade is formed in the first end portion of the handle body, and wherein the recess has an engagement surface for contacting the trapezoidal utility blade, and wherein a cuff extends along a margin of the engagement surface for overhanging the trapezoidal utility blade.

In at least one example, an insert is positioned in a hole defined through the first end portion of the handle body, the insert having a threaded interior.

In at least one example, a locking screw has a threaded shank engaging the threaded interior of the insert for retaining the trapezoidal utility blade.

In at least one example, the locking screw and insert are constructed of the same material.

In at least one example, a lanyard hole is formed through the handle body.

In at least one example, the handle body has a generally circular profile when viewed in the second longitudinal direction.

In at least one example, the handle body further includes: a central portion; a first diameter-reduced portion connecting the central portion to the first end portion, the first diameter-reduced portion being thinner than the central portion and the first end portion; and a second diameter-reduced portion connecting the central portion to the second end portion, the second diameter-reduced portion being thinner than the central portion and the second end portion.

In at least one example, the handle body further includes a first lateral side in which at least one slot is formed to permit use of the multifunction tool as a wrench.

In at least one example, the handle body further includes a first lateral side in which at least a first slot having a first length and a second slot having a second length are formed to permit use of the multifunction tool as a wrench, wherein the second length is different from the first length.

In at least one example, a flat surface area of the handle body surrounds the first and second slot.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a side view of a multifunction tool according to at least one embodiment.

FIG. 2 is an end view of the tool of FIG. 1 as viewed longitudinally from a first end.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

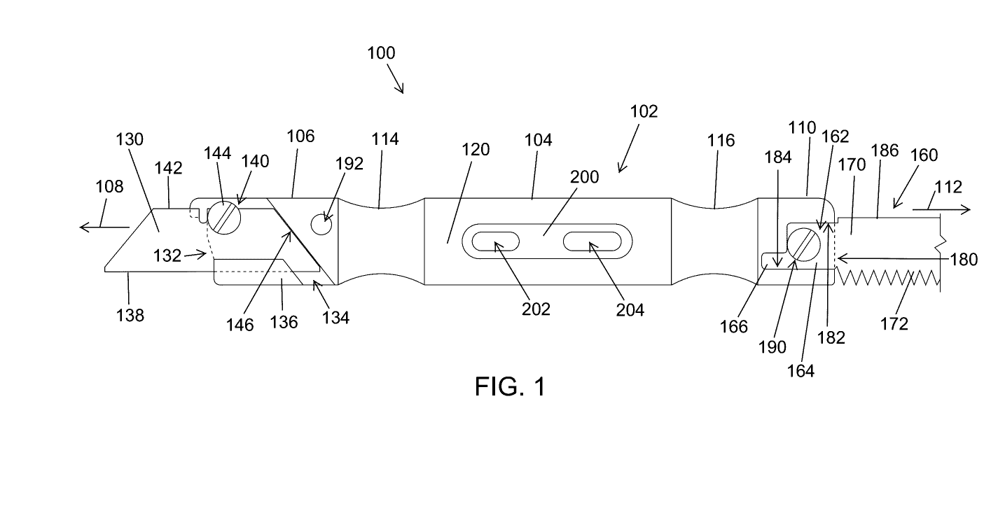

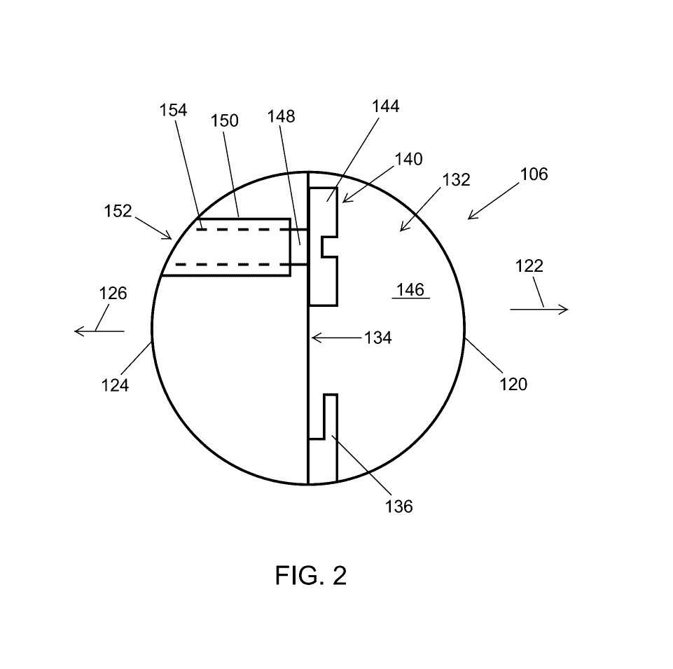

A multifunction tool 100 according to at least one embodiment is shown in FIG. 1. The tool 100 includes a longitudinally extending handle body 102 that has a generally circular profile, in the illustrated embodiment, when viewed end-wise as shown in FIG. 2. The handle body 102 has a longitudinally extending central portion 104, a longitudinal first end portion 106 extending from the central portion 104 in a first longitudinal direction 108, and a longitudinal second end portion 110 opposite the first end portion 106 and extending in a second longitudinal direction 112 opposite the first longitudinal direction 108. FIG. 2 is an end view of the first end portion 106 of the multifunction tool 100 of FIG. 1 as viewed facing the second direction 112.

The first end portion 106 of the handle body 102 is connected to the central portion 104 (FIG. 1) by a first diameter-reduced portion 114 that is thinner than the central portion 104 and first end portion 106. Similarly, the second end portion 110 of the handle body 102 is connected to the central portion 104 by a second diameter-reduced portion 116 that is thinner than the central portion 104 and second end portion 110. The diameter-reduced portions 114 and 116 are longitudinally spaced from each other by an approximate dimension of the palm of the hand of an adult to facilitate grip and handling of the multifunction tool 100. The handle body 102 has a lateral first side 120 facing a first lateral direction 122, and an opposite lateral second side 124 facing a second lateral direction 126 opposite the first lateral direction 122 (FIG. 2).

The first end portion 106 of the handle body 102 is adapted to removably carry and wield a replaceable blade 130 (FIG. 1). In particular, a first recess 132 is defined in the first end portion 106 to receive and retain the blade 130. The first recess 132 has a flat first engagement surface 134 facing the first lateral direction 122 in the illustrated embodiment. The flat first engagement surface 134 faces and contacts the blade 130 when a blade 130 is installed. A longitudinally extending cuff 136 connected to the first end portion 106 along a margin of the first engagement surface 134 partially overhangs and engages the cutting edge 138 of the blade 130. A locking screw 140 engages one of two locking detents defined in the non-cutting edge 142 of the blade 130 opposite the cutting edge 138. The locking screw 140 has a head 144 that overhangs and contacts a portion of the blade 130 proximal the locking detent when the locking screw 140 is tightened. Thus the blade 130 is trapped in the installed position as shown in FIG. 1 by the first engagement surface 134, cuff 136, and locking screw 142.

The blade 130 is further abutted and engaged by an abutment 146 that faces at least partially in the first direction 108 in the illustrated embodiment. In the illustrated example, the first end portion 106 of the handle body 102 is particularly adapted to removably carry and wield a trapezoidal utility blade 130, and thus the abutment 146 is sloped at a non-right angle toward the cuff 136 so as to meet and engage a dovetail edge of the blade adjacent the cutting edge 138.

Other exemplary standardized replaceable blade configurations are within the scope of these descriptions. For example, a shroud cutter blade may be used and may be useful to, for example, free the user from parachute cords once back on the ground or in a tree after escaping an aircraft.

A laterally extending internally threaded bore may be defined in the first engagement surface 134 to receive and engage the threaded shank 148 (FIG. 2) of the locking screw 140 so as to retain the screw and blade 130. Advantageously however, in the illustrated example, an insert 150 (FIG. 2) is pressed into a hole 152 defined through the first end portion 106 of the handle body 102 from the lateral second side 124 to the flat engagement surface 134 (FIG. 2). In that example, the hole 152 may have a greater diameter toward the second lateral side 124 than toward the flat engagement surface 134 and the insert 150, which is pressed into the hole 152 from the second side 124, is trapped unable to pass through to the flat engagement surface 134. The insert 150 in the illustrated embodiment of FIG. 2, has a threaded interior 154 that receives and engages the threaded shank 148 of the locking screw 140 so as to retain the screw 140 and blade 130.

The second end portion 110 of the handle body 102 is adapted to removably carry and wield a standard reciprocating saw blade 160, which is of a type known as a reciprocating saw blade with a one-half (½) inch universal tang 162. The universal tang 162 has a standard rectangular rear tang portion 164, through which a mounting hole is formed, and a registration tab 166 that extends longitudinally rearward from the rectangular tang portion 164 to assure proper orientation of the saw blade 160 in its mounting upon the multifunction tool 100. A forward blade portion 170 extends longitudinally forward (shown as in the second longitudinal direction 112 in FIG. 1) from the tang 162 and has a cutting edge 172. The cutting edge 172 is illustrated as having cutting teeth to represent many types of toothed blades.

For example, the cutting edge 172 may have an aggressive triangular tooth configuration for cutting materials such as wood. The cutting edge 172 may have small teeth for cutting metal and other non-wood materials. That is, a variety of reciprocating saw blades with one-half (½) inch universal tangs 162 can be mounted on the second end portion 110 of the multifunction tool 100. Additional exemplary saw blades include, but are not limited to, blades for pruning, and blades for demolition. The multifunction tool 100 may include or carry a carbide tip for cracking windows and other materials.

To accommodate the universal tang 162, a second recess 180 is defined in the second end portion 110 of the handle body 102 to receive and retain the blade 160. The second recess 180 has a flat second engagement surface (hidden by the tang 162 in FIG. 1) facing the first lateral direction 122 (FIG. 2) in the illustrated embodiment. The flat second engagement surface faces and contacts the tang 162 when a blade 160 is installed. The second recess 180 is shaped to receive and engage the standard one-half (½) inch universal tang 160, which includes the rectangular rear tang portion 164 and the registration tab 166.

A locking screw 190 secures the blade 160 to the second end portion 110 of the multifunction tool 100 through the mounting hole (hidden by the screw 190 in FIG. 1) formed in the rectangular rear tang portion 164 of the blade.

A laterally extending internally threaded bore may be defined in the second engagement surface to receive and engage the threaded shank of the locking screw 190 so as to retain the screw and blade 160. Advantageously however, as described above with reference to FIG. 2 and the first end portion 106 of the handle body 102 and the blade, an insert having a threaded interior may pressed into a hole defined through the second end portion 110 of the handle body 102 from the lateral second side 124, such that the insert receives and engages the threaded shank of the locking screw 190 so as to retain the screw and blade 160.

The second recess 180 is defined between opposing and longitudinally extending first and second bracing surfaces 182 and 184. When the blade 160 is installed, the first bracing surface 182 engages the margin of the tang 162 that extends from the non-cutting edge 186 of the blade 160, whereas the second bracing surface 184 engages the margin of the tang 162 that extends from the cutting edge 172 of the blade. Accordingly, the second bracing surface 184, which engages both the rectangular rear tang portion 164 of the tang 162 and the registration tab 166, is longer than the first bracing surface 182, which engages the rectangular rear tang portion 164. The second recess 180 is open toward the second longitudinal direction 112 (FIG. 1) and the first lateral direction 122 (FIG. 2).

The handle body 102 in at least one embodiment is made of 6061, 6062 or 6063 aluminum. In another embodiment the handle body 102 is made of titanium. Other materials are within the scope of these descriptions. The handle body 102 may be anodized. The inserts described above may be formed of same or similar material as the locking screws, for example stainless steel, to prevent galling as may otherwise occur between dis-similar metals. The locking screws 140 and 190 are illustrated as slotted flat-head machine screws, which are conveniently operable using flat available items including washers and coins, which may be used when a conventional screwdriver is not available. Nonetheless, the descriptions relate as well to other screw configurations and other drivers whether conventional or improvised. A small screwdriver may be attached to the tool by a lanyard. A pouch may be included to hold the tool and the pouch may have pockets to hold a screwdriver and/or additional blades for variety. A lanyard hole 192 is illustrated as formed through the first end portion 106 of the handle body 102. A lanyard hole in other embodiments can be provided in other locations or portions along the handle body 102.

The multifunction tool 100 is advantageously non-powered in the illustrated embodiment in that no motor is provided, thus no power source is utilized. The multifunction tool 100 thus serves as a hand tool to be grasped and used by hand without other power assistance being required.

In the illustrated embodiment as shown in FIG. 1, a flattened surface area 200 is defined at least along the exterior of the central portion 104 of the handle body 102 along the lateral first side 120. The flattened surface area 200 may be machined flat or otherwise formed. One or more slots, having openings defined in the flattened surface area 200, may be formed into the central portion 104 of the handle body 102 as illustrated in FIG. 1. Two slots are shown in FIG. 1 to provide an example in which multiple slots of different sizes can be used for different functions. In the illustrated example, two slots 202 and 204 are formed and are dimensioned to permit use of the multifunction tool 100 as a wrench. For example, the slots may be dimensioned for use of the multifunction tool 100 as an oxygen wrench able to engage standard sized tab-end extensions of oxygen bottle valves. In FIG. 1, for example, the first slot 202 may be approximately: 0.505 inch in longitudinal length, 0.217 inch in width (as taken perpendicular to either longitudinal direction 108 and 112), and 0.25 inch in depth (as formed into the flattened surface area 200). The second slot 204 may be approximately: 0.635 inch in length, 0.217 inch in width, and 0.25 inch in depth (as formed into the flattened surface area).

Any number of slots for use of the multifunction tool 100 in various as a wrench and for other tool functions can be included. A flattened surface area may also be defined along the lateral second side 124, and one or more slots may be formed into the second side similarly as shown for the first side 120 in FIG. 1, although similar or different dimensions may be used for slots along the second side. Exterior portions of the handle body 102 may be knurled for gripping.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A multifunction hand tool for mounting thereon a one-half inch universal tang reciprocating saw blade having a rectangular tang portion extending from a blade and a registration tab extending from the rectangular tang portion, the multifunction tool comprising:
a handle body, the handle body comprising:
a first end portion extending in a first longitudinal direction;
a second end portion extending in a second longitudinal direction opposite the first longitudinal direction; and
a recess formed in the second end portion and shaped to receive and engage a rectangular tang portion and a registration tab of a one-half inch universal tang reciprocating saw blade.

2. The multifunction hand tool of claim 1, wherein the multifunction hand tool is non-powered.

3. The multifunction hand tool of claim 1, wherein the recess is defined between a longitudinally extending first bracing surface and a longitudinally extending second bracing surface.

4. The multifunction hand tool of claim 3, wherein the second bracing surface, for engaging a rectangular rear tang portion and a registration tab of a one-half inch universal tang reciprocating saw blade, is longer than the first bracing surface, for engaging a rectangular rear tang portion of a one-half inch universal tang reciprocating saw blade.

5. The multifunction hand tool of claim 1, wherein a recess for receiving a trapezoidal utility blade is formed in the first end portion of the handle body, and wherein the recess has an engagement surface for contacting the trapezoidal utility blade, and wherein a cuff extends along a margin of the engagement surface for overhanging the trapezoidal utility blade.

6. The multifunction hand tool of claim 5, further comprising an insert positioned in a hole defined through the first end portion of the handle body, the insert having a threaded interior.

7. The multifunction hand tool of claim 6, further comprising a locking screw having a threaded shank engaging the threaded interior of the insert for retaining the trapezoidal utility blade.

8. The multifunction hand tool of claim 7, wherein the locking screw and insert are constructed of the same material.

9. The multifunction hand tool of claim 1, wherein a lanyard hole formed through the handle body.

10. The multifunction hand tool of claim 1, wherein the handle body has a generally circular profile when viewed in the second longitudinal direction.

11. The multifunction hand tool of claim 1, wherein the handle body further comprises:
a central portion;
a first diameter-reduced portion connecting the central portion to the first end portion, the first diameter-reduced portion being thinner than the central portion and the first end portion; and
a second diameter-reduced portion connecting the central portion to the second end portion, the second diameter-reduced portion being thinner than the central portion and the second end portion.

12. The multifunction hand tool of claim 1, wherein the handle body further comprises a first lateral side in which at least one slot is formed to permit use of the multifunction tool as a wrench.

13. The multifunction hand tool of claim 1, wherein the handle body further comprises a first lateral side in which at least a first slot having a first length and a second slot having a second length are formed to permit use of the multifunction tool as a wrench, wherein the second length is different from the first length.

14. The multifunction hand tool of claim 13, a flat surface area of the handle body surrounds the first and second slot.
